(19) United States
(12) Patent Application Publication
(10) Pub. No.: US 2022/0025121 A1
(43) Pub. Date: Jan. 27, 2022

(54) METHOD FOR PRODUCING POLYARYLENE SULFIDE

(71) Applicant: Kureha Corporation, Tokyo (JP)

(72) Inventors: Takeshi Sato, Tokyo (JP); Ken-ichi Takaki, Tokyo (JP); Yoshinori Suzuki, Tokyo (JP)

(73) Assignee: Kureha Corporation, Tokyo (JP)

(21) Appl. No.: 17/296,762

(22) PCT Filed: Nov. 22, 2019
(86) PCT No.: PCT/JP2019/045796

§ 371 Date: May 25, 2021

(30) Foreign Application Priority Data
Dec. 13, 2018 (JP) 2018-233590

(51) Int. Cl. C08G 75/0259; C08G 75/0213

(52) U.S. Cl. CPC C08G 75/0259; C08G 75/0213

(57) ABSTRACT

In production of a polyarylene sulfide (PAS), combination/coalescence and enlargement of the PAS are prevented. A method for producing a PAS according to the present invention includes: first polymerization in which a mixture containing a sulfur source and a dihalo aromatic compound in an organic amide solvent is heated to initiate a polymerization reaction; second polymerization in which a first temperature (T₁) is maintained after adding a phase separation agent to continue the reaction; third polymerization in which a second temperature (T₂) is maintained to continue the reaction; and fourth polymerization in which the reaction is continued at a third temperature (T₃), wherein a relationship among the temperatures is T₁>T₃>T₂.

### TECHNICAL FIELD

The present invention relates to a method for producing a polyarylene sulfide.

### BACKGROUND ART

Polyarylene sulfides (hereinafter also abbreviated as “PASs”) such as polyphenylene sulfides (“PPSs”) are engineering plastics with excellent heat resistance, chemical resistance, flame retardancy, and the like. PASs can be molded into various molded products, films, sheets, fibers, and the like by common melt processing methods, such as injection molding, extrusion molding, and compression molding and thus have been widely used as raw materials for resin components in a wide variety of fields, such as electrical/electronic devices, automobile devices, and chemical devices.

Representative methods known for producing a PAS includes a method for polymerization reaction of a sulfur source and a dihalo aromatic compound in an organic amide solvent, such as, for example, N-methyl-2-pyrrolidone (hereinafter also abbreviated as “NMP”).

A two-stage polymerization method is known for producing a high molecular weight PAS. In this method, a prepolymer is produced in a step of first-stage polymerization, then a phase separation agent is added, and the polymerization is continued in a step of second-stage polymerization. In such a technique, the polymerization is known to proceed in a liquid-liquid phase separation state (a dispersed phase is a concentrated polymer solution phase, and a continuous phase is a dilute polymer solution phase) to provide a high molecular weight polymer in granular form.

The polymer produced by the polymerization reaction in the phase-separated state converges to a certain particle size but combines/coalesces to cause enlargement and coarse granulation of the particles and further agglomerates. This may result in poor handling properties, such as difficulty in stirring and removing the polymer from a polymerization vessel or the like.

To solve the problems described above, several methods have been proposed including, for example, devising the timing of introducing a phase separation agent after the first-stage polymerization (Patent Document 1) and devising polymerization conditions for the second stage (Patent Documents 2 and 3). In addition, as in Patent Document 4, two-stage polymerization at different polymerization temperatures in a system where no phase separation agent is added has been also proposed.

### CITATION LIST

### Patent Document

Patent Document 1: JP 2003-096190 A
Patent Document 2: JP 08-013887 B
Patent Document 3: JP 08-041201 A
Patent Document 4: JP 06-072186 B

### SUMMARY OF INVENTION

### Technical Problem

However, the production methods of Patent Documents 1 to 4 have room for improvement from the perspectives, such as shorter polymerization time, better yield and handling properties. Thus, the present invention was made in view of the above problems, and an object of the present invention is to produce a high molecular weight polyarylene sulfide with excellent handling properties but without combination/coalescence and enlargement.

### Solution to Problem

To solve the above problems, the method for producing a polyarylene sulfide according to the present invention is a production method including: first polymerization in which a mixture containing a sulfur source and a dihalo aromatic compound in an organic amide solvent is heated to initiate a polymerization reaction and produce a reaction mixture; phase separation agent addition in which a phase separation agent is added to the reaction mixture obtained in the first polymerization; second polymerization in which a predetermined first temperature (T₁) from 240° C. to 290° C. is maintained for 10 minutes or longer after the phase separation agent addition to continue the polymerization reaction; third polymerization in which a predetermined second temperature (T₂) from 235° C. to 245° C. is maintained for shorter than 2 hours after the second polymerization to continue the polymerization reaction; and fourth polymerization in which the polymerization reaction is continued at a predetermined third temperature (T₃) of 240° C. or higher and lower than 250° C. after the third polymerization, wherein a relationship among T₁, T₂, and T₃ is T₁>T₃>T₂.

### Advantageous Effects of Invention

Through the production method according to the present invention, a high molecular weight polyarylene sulfide with excellent handling properties but without combination/coalescence and enlargement can be produced.

### DESCRIPTION OF EMBODIMENTS

An embodiment of the method for producing a polyarylene sulfide according to the present invention will be described.

The method for producing a polyarylene sulfide according to the present embodiment includes first polymerization, phase separation agent addition, second polymerization, third polymerization, and fourth polymerization. In the first polymerization, a mixture containing a sulfur source and a dihalo aromatic compound in an organic amide solvent is heated to initiate a polymerization reaction and produce a reaction mixture containing a prepolymer. In the phase separation agent addition, a phase separation agent is added to the reaction mixture obtained in the first polymerization. In the second polymerization, the reaction mixture containing the added phase separation agent is maintained at a predetermined first temperature (T₁) from 240° C. to 290° C. for 10 minutes or longer to continue the polymerization reaction. In the third polymerization, a predetermined second temperature (T₂) from 235° C. to 245° C. is maintained for shorter than 2 hours after the second polymerization to continue the polymerization reaction. In the fourth polymerization, the polymerization reaction is continued at a predetermined third temperature (T₃) of 240° C. or higher and lower than 250° C. after the third polymerization.

### Compounds Used

Prior to describing the method for producing a polyarylene sulfide in the present embodiment, compounds used in the method for producing a polyarylene sulfide in the present embodiment will be described.

### 1. Sulfur Source

In the present embodiment, hydrogen sulfide, an alkali metal sulfide, or an alkali metal hydrosulfide, or a mixture of these is used as the sulfur source for producing a PAS.

Examples of the alkali metal sulfide include, but is not limited to, lithium sulfide, sodium sulfide, potassium sulfide, rubidium sulfide, cesium sulfide, and mixtures of two or more of these. Among these, the alkali metal sulfide is preferably sodium sulfide from the perspective that it is industrially available at a low price and easy to handle.

Examples of the alkali metal hydrosulfide include, but is not limited to, lithium hydrosulfide, sodium hydrosulfide, potassium hydrosulfide, rubidium hydrosulfide, cesium hydrosulfide, and mixtures of two or more of these. Among these, sodium hydrosulfide and lithium hydrosulfide are preferred in terms of being industrially available at a low price.

### 2. Dihalo Aromatic Compound

The dihalo aromatic compound used as a raw material for producing a PAS is a dihalogenated aromatic compound having two halogen atoms directly bonded to an aromatic ring. Specific examples of the dihalo aromatic compound include o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide, and dihalodiphenyl ketone. These dihalo aromatic compounds can each be used alone or in combination of two or more.

Here, the halogen atom is selected from fluorine, chlorine, bromine, and iodine and is preferably chlorine. Two halogen atoms in one dihalo aromatic compound may be the same or different.

As the dihalo aromatic compound, o-dichlorobenzene, m-dichlorobenzene, p-dichlorobenzene, or a mixture of two or more of these is suitably used.

### 3. Organic Amide Solvent

In the present embodiment, as a solvent for a dehydration reaction in water removal described later and a polymerization reaction, an organic amide solvent, which is an aprotic polar organic solvent, is used. The organic amide solvent is preferably stable to alkali at high temperatures.

Specific examples of the organic amide solvent include amide compounds, such as N,N-dimethylformamide and N,N-dimethylacetamide; N-alkylcaprolactam compounds, such as N-methyl-c-caprolactam; N-alkylpyrrolidone compounds or N-cycloalkylpyrrolidone compounds, such as N-methyl-2-pyrrolidone and N-cyclohexyl-2-pyrrolidone; N,N-dialkylimidazolidinone compounds, such as 1,3-dialkyl-2-imidazolidinone; tetraalkyl urea compounds, such as tetramethyl urea; and hexaalkylphosphoric triamide compounds, such as hexamethylphosphoric triamide. These organic amide solvents can each be used alone or in combination of two or more.

Among these organic amide solvents, N-alkyl pyrrolidone compounds, N-cycloalkyl pyrrolidone compounds, N-alkyl caprolactam compounds, and N,N-dialkyl imidazolidinone compounds are preferred; NM P, N-methyl-ε-caprolactam, and 1,3-dialkyl-2-imidazolidinone are more preferred; and NMP is particularly preferred.

### 4. Phase Separation Agent

In the present embodiment, a phase separation agent is used to form a liquid-liquid phase separation state and to obtain a PAS with an adjusted melt viscosity in a short time. The phase separation agent is a compound that dissolves in an organic amide solvent alone or in the presence of an organic amide solvent and a small amount of water and has an effect of reducing the solubility of a PAS in the organic amide solvent. The phase separation agent is a compound that is not a solvent for PASs.

As the phase separation agent, a compound well-known as a phase separation agent for PASs can be used. The phase separation agent also includes compounds used as a polymerization auxiliary agent described later, but the phase separation agent in the present specification means a compound used in an amount ratio that allows the compound to function as a phase separation agent in a phase separation polymerization reaction. The phase separation agents are broadly classified into water and phase separation agents other than water. Specific examples of the phase separation agents other than water include metal salts of organic carboxylic acids; metal salts of organic sulfonic acids; alkali metal halides, such as halogenated lithium; alkaline earth metal halides; alkaline earth metal salts of aromatic carboxylic acids; alkali metal salts of phosphoric acid; alcohols; and paraffin hydrocarbons. The metal salt of an organic carboxylic acid is preferably an alkali metal carboxylate, such as lithium acetate, sodium acetate, potassium acetate, sodium propionate, lithium valerate, lithium benzoate, sodium benzoate, sodium phenyl acetate, and potassium p-toluate. These phase separation agents can be each used alone or in combination of two or more. Among these phase separation agents, from the perspective of low cost and easy post-treatment, water or a combination of water and a metal salt of an organic carboxylic acid, such as an alkali metal carboxylate, is particularly preferred.

### 5. Alkali Metal Hydroxide

When the sulfur source contains an alkali metal hydrosulfide or hydrogen sulfide, an alkali metal hydroxide is used in combination. In addition, when only an alkali metal hydrosulfide is used as the sulfur source, an alkali metal hydroxide may also be added in water removal as described later. Examples of the alkali metal hydroxide include, but is not limited to, lithium hydroxide, sodium hydroxide, potassium hydroxide, rubidium hydroxide, cesium hydroxide, and mixtures of two or more of these. Among these, sodium hydroxide is preferred in terms of being industrially available at a low price.

### 6. Polymerization Auxiliary Agent

In the present embodiment, a polymerization auxiliary agent of various types can be used as necessary to accelerate the polymerization reaction. As the polymerization auxiliary agent, a compound well-known as a polymerization auxiliary agent for PASs can be used. Examples of such a compound include metal salts of organic sulfonic acids, halogenated lithium, metal salts of organic carboxylic acids, and alkali metal salts of phosphoric acid. The amount of the polymerization auxiliary agent to be used depends on the type of the compound and is from 0.001 to 1 mol, preferably from 0.005 to 0.3 mol, and more preferably from 0.01 to 0.1 mol per mole of the charged sulfur source.

### Method for Producing Polyarylene Sulfide

Then, an embodiment of the method for producing a polyarylene sulfide will be described. The production method of the present embodiment includes a water removal step and a preparation step as steps prior to the first polymerization step and includes a cooling step and a post-treatment step as steps after the fourth polymerization step.

### Water Removal Step

In the water removal, at least a portion of water contained in a raw material used in the polymerization reaction is removed. The sulfur source usually contains water, such as water of hydration (crystal water). In addition, when the sulfur source and an alkali metal hydroxide are used as an aqueous mixture, which is a preferred form, water is contained as a medium. The polymerization reaction of the sulfur source and the dihalo aromatic compound is affected by the content of water present in the polymerization reaction system. Thus, in the present embodiment, the water removal step is provided prior to the polymerization to adjust the water content in the polymerization reaction system.

In the present embodiment, a mixture containing the organic amide solvent and the sulfur source that may contain an alkali metal hydroxide is heated to discharge at least a portion of the distillate containing water out of the system containing the mixture in the water removal step. The organic amide solvent here is a solvent used as a medium in the water removal step. However, in terms of using the same organic amide solvent as the medium in the polymerization reaction, the organic amide solvent used in the water removal step is preferably the same as the organic amide solvent used in the polymerization. Among others, NMP is readily available industrially and thus is more preferred.

Water is removed by a method of charging raw materials to be subjected to water removal and the organic amide solvent into a reaction vessel and then heating a mixture containing these. The heating conditions may be, for example, 300° C. or lower and preferably a temperature range of 100 to 250° C., and, for example, from 15 minutes to 24 hours and preferably from 30 minutes to 10 hours.

The amount of the organic amide solvent to be charged is from 100 to 1000 g, preferably from 150 to 750 g, and more preferably from 200 to 500 g per mole of the sulfur source when charged.

When the sulfur source contains a sulfur source other than an alkali metal sulfide, an alkali metal hydroxide is added. The amount to be added is the amount required to convert the sulfur source into an alkali metal sulfide. That is, when the sulfur source contains only an alkali metal hydrosulfide, an alkali metal hydroxide in an equimolar amount to that of the alkali metal hydrosulfide is added.

Then, the molar amount of the alkali metal hydroxide when charged per mole of the sulfur source when charged is preferably adjusted to 0.75 to 1.1 mol. Here, when an alkali metal sulfide is used as the sulfur source, the calculation is made on the basis that an alkali metal hydroxide in an equimolar amount to that of the alkali metal sulfide is contained. That is, when a condition is set as an alkali metal hydroxide/the sulfur source ratio of greater than 1, the alkali metal hydroxide in an amount corresponding to the shortage to the set value is added for adjustment. On the other hand, when the condition is set to be less than 1, the alkali metal hydrosulfide in an equimolar amount to that of the excess amount from the set value is added for adjustment. For example, when a condition is set as an alkali metal hydroxide/the sulfur source ratio of 1.075 and only an alkali metal sulfide is used as the sulfur source, an amount of 1 of the alkali metal hydroxide is already contained, and thus an amount of 0.075 of the alkali metal hydroxide is to be added.

In the water removal step, a portion of water and the organic amide solvent is distilled out of the system by heating. Thus, the distillate contains water and the organic amide solvent. To prevent the discharge of the organic amide solvent out of the system, a portion of the distillate may be refluxed into the system. However, to adjust the water content in the mixture, at least a portion of the distillate containing water is discharged out of the system.

In the water removal step, hydrogen sulfide originating from the sulfur source may be volatilized. In this case, as at least a portion of the distillate containing water is discharged out of the system, volatilized hydrogen sulfide is also discharged out of the system. Hydrogen sulfide discharged out of the system may be recovered and returned to the system.

In the water removal step, water, such as water of hydration, a water medium, and byproduct water, is removed until the water amount is within a desired range. When the water contentis too low in the water removal step, the water content can be adjusted to a desired amount by adding water in the preparation step described next. In addition, when a large amount of the sulfur source is volatilized, the sulfur source may be supplemented in the preparation step.

### Preparation Step

In the preparation step, a mixture (hereinafter referred to as a “charged mixture”) containing desired amounts of the organic amide solvent and the sulfur source, as necessary, the alkali metal hydroxide, water, and the dihalo aromatic compound using the mixture remaining in the system after the water removal step. The subsequent polymerization reaction is performed using the charged mixture prepared.

In the present specification, when the amount of the sulfur source in the charged mixture is referred to, the sulfur source is expressed as a “charged sulfur source”. This is because the amount of the sulfur source charged in the water removal step may differ from the amount of the sulfur source in the charged mixture due to the volatilization in the water removal step and is to distinguish these amounts. That is, in the present embodiment, the amount of the charged sulfur source can be calculated by subtracting the molar amount of hydrogen sulfide volatilized in the water removal step from the molar amount of the sulfur source charged in the water removal step except for the case where the sulfur source is supplemented in the preparation step. In addition, when the sulfur source charged in the water removal step is a mixture of two or more compounds selected from hydrogen sulfide, an alkali metal sulfide, and an alkali metal hydrosulfide, the total molar amount of these compounds is used as the molar amount of the sulfur source.

The dihalo aromatic compound in the charged mixture is used in an amount preferably from 0.9 to 1.5 mol, more preferably from 0.92 to 1.10 mol, and even more preferably from 0.92 to 1.05 per mole of the charged sulfur source.

To achieve suitable reaction conditions, adjustment of the water content is important. In the first polymerization described below, if the amount of coexisting water as moisture is too small, an unfavorable reaction, such as a decomposition reaction of the produced polymer would be likely to occur. On the other hand, if the amount of coexisting water is too large, the polymerization reaction rate would be significantly slow or a decomposition reaction would occur. From the above perspectives, the water content in the charged mixture is preferably adjusted to 0.5 to 2.4 mol, more preferably adjusted to 0.8 to 2.0 mol, and even more preferably adjusted to 1.0 to 1.8 mol per mole of the charged sulfur source. In this case, the water content needs to be adjusted in light of water that can be produced in association with the production of the alkali metal sulfide by the reaction of the alkali metal hydrosulfide and the alkali metal hydroxide in the water removal step and water consumed in association with the volatilization of hydrogen sulfide from the alkali metal sulfide or alkali metal hydrosulfide in the water removal step.

Thus, a preferred aspect of the charged mixture is a mixture containing from 0.92 to 1.05 mol of the dihalo aromatic compound per mole of the charged sulfur source and having a water content adjusted to 1.0 to 1.8 mol per mole of the charged sulfur source.

In addition, the amount of the alkali metal hydroxide in the charged mixture is preferably from 0.95 to 1.075 mol, more preferably from 0.98 to 1.070 mol, even more preferably from 0.99 to 1.065 mol, and particularly preferably from 1.0 to 1.06 mol per mole of the charged sulfur source. In this case, the amount of the alkali metal hydroxide is a total amount of the alkali metal hydroxide charged in the water removal step, the alkali metal hydroxide produced in association with the production of hydrogen sulfide volatilized in the water removal step, and the alkali metal hydroxide added in the preparation step. When an alkali metal sulfide is used as the sulfur source, the calculation is made on the basis that an alkali metal hydroxide in an equimolar amount to that of the alkali metal sulfide is contained. When the amount of the alkali metal hydroxide is less than the set value, the alkali metal hydroxide in an amount corresponding to the insufficient amount relative to the set value is added for adjustment. On the other hand, when the amount of the alkali metal hydroxide exceeds the set value, the alkali metal hydrosulfide in an equimolar amount to that of the excess amount relative to the set value is added for adjustment. Adjusting the molar ratio of the alkali metal hydroxide to the charged sulfur source to the range described above can suppress deterioration of the organic amide solvent and prevent occurrence of an abnormal reaction during polymerization. Furthermore, this can prevent decreases in the yield and quality of the PAS produced.

The amount of the organic amide solvent in the charged mixture is from 100 to 1000 g, preferably from 150 to 750 g, and more preferably from 200 to 500 g per mole of the charged sulfur source.

The amount ratio (molar ratio) of each component in the charged mixture is adjusted by adding a necessary component to the mixture obtained in the water removal step. The dihalo aromatic compound is added to the mixture in the preparation step. When the amounts of the alkali metal hydroxide, water, and the like in the mixture obtained in the water removal step are small, these components are added in the preparation step. When the amount of the organic amide solvent distilled is too large in the water removal step, the organic amide solvent is added in the preparation step. In addition, the sulfur source may be added in the preparation step to adjust the charged sulfur source. Thus, in the preparation step, the sulfur source, the organic amide solvent, water, and the alkali metal hydroxide may be added as necessary in addition to the dihalo aromatic compound.

### First Polymerization

In the first polymerization, the mixture containing the sulfur source and the dihalo aromatic compound in the organic amide solvent is heated to initiate a polymerization reaction and produce a reaction mixture. The reaction mixture may contain a prepolymer.

The temperature in the first polymerization is from 170° C. to 290° C. From the perspective of preventing a side reaction, the temperature is preferably from 170 to 280° C., more preferably from 170 to 270° C., and particularly preferably from 170 to 260° C.

In the first polymerization, the polymerization reaction is to be performed until a conversion rate of the dihalo aromatic compound is finally from 50 to 98 mol %, but the final conversion rate of the dihalo aromatic compound in the first polymerization is preferably from 65 to 96 mol % and more preferably from 70 to 95 mol %. The final conversion rate of the dihalo aromatic compound in the first polymerization within the range described above can increase the molecular weight of the prepolymer, thus achieving an increase in molecular weight.

The conversion rate of the dihalo aromatic compound can be calculated based on the residual amount of the dihalo aromatic compound remaining in the reaction mixture, which is determined by gas chromatography, the charged amount of the dihalo aromatic compound, and the charged amount of the sulfur source. Specifically, when the dihalo aromatic compound represented by “DHA” is added in an excess molar ratio to the sulfur source, the conversion rate can be calculated by Equation 1 below:

Conversion rate=[charged amount (mol) of DHA—residual amount (mol) of DHA]/[charged amount (mol) of DHA—excess amount (mol) of DHA] (1)

In the case other than the above, the conversion rate can be calculated by Equation 2 below:

Conversion rate=[charged amount (mol) of DHA—residual amount (mol) of DHA]/[charged amount (mol) of DHA] (2)

The “excess amount of DHA” in Formula (1) above is an excess amount of the dihalo aromatic compound to the amount of the sulfur source. Thus, [charged amount (mol) of DHA—excess amount (mol) of DHA] in Formula (1) above is substantially equal to the amount (mol) of the charged sulfur source.

From the perspective of productivity, time for the first polymerization is preferably from 2 to 10 hours, more preferably from 2 to 8 hours, and even more preferably approximately from 2 to 6 hours.

### Phase Separation Agent Addition

In the production method according to the present embodiment, the reaction system is separated into a concentrated polymer phase and a dilute polymer phase. Then, to continue the polymerization reaction in this concentrated polymer phase, a phase separation agent is added to the reaction mixture obtained in the first polymerization to form a liquid-liquid phase separation state. Specifically, a state in which the concentrated polymer phase is dispersed as droplets in the dilute polymer phase is formed. The liquid-liquid phase separation state can be formed by increasing the temperature of the polymerization system in the presence of the phase separation agent.

When water is used as the phase separation agent, water is preferably added so that the total water content including water present in the reaction mixture is greater than 2 mol and 10 mol or less per mole of the charged sulfur source. In addition, from the perspective of increasing the molecular weight and reducing the polymerization time, water is more preferably added so that the total water content is from 2.3 to 7 mol and even more preferably added so that the total water content is from 2.5 to 5 mol.

When a mixture of water and a phase separation agent other than water is used as the phase separation agent, water is in an amount so that the total water content including water present in the reaction mixture is preferably from 0.01 to 7 mol, more preferably from 0.1 to 6 mol, and even more preferably from 1 to 4 mol per mole of the charged sulfur source. On the other hand, the amount of the phase separation agent other than water is preferably from 0.01 to 3 mol, more preferably from 0.02 to 2 mol, and even more preferably from 0.03 to 1 mol per mole of the charged sulfur source.

In the present embodiment, when the phase separation agent is added to the reaction mixture obtained in the first polymerization, an alkali metal hydroxide is added so that the total amount of the alkali metal hydroxide in the reaction mixture is from 1.00 to 1.09 mol per mole of the charged sulfur source. When an alkali metal sulfide is used as the sulfur source, the calculation is made on the basis that an alkali metal hydroxide in an equimolar amount to that of the alkali metal sulfide is already contained. When the amount of the alkali metal hydroxide is below the set value, the alkali metal hydroxide in an amount corresponding to the insufficient amount relative to the set value is added for adjustment. On the other hand, when the amount of the alkali metal hydroxide exceeds the set value, the alkali metal hydrosulfide in an equimolar amount to that of the excess amount relative to the set value is added for adjustment. Adding the alkali metal hydroxide allows the subsequent polymerization reaction to stably proceed.

### Second Polymerization

In the second polymerization, a phase separation agent is added to the reaction mixture obtained in the first polymerization and a predetermined first temperature (T₁) of 240° C. to 290° C. is maintained for 10 minutes or longer to continue the polymerization reaction. The reaction system is controlled at high temperature in the presence of the phase separation agent and thus is in a liquid-liquid phase separation state, and the polymerization reaction is performed in the phase-separated state.

The predetermined first temperature (T₁), which is the polymerization temperature in the second polymerization, is 240° C. to 290° C. but is preferably 250° C. or higher and more preferably 255° C. or higher. In addition, the first temperature is preferably 280° C. or lower and more preferably 270° C. or lower. In the present specification, “maintaining a predetermined temperature (Tₓ)” refers to maintaining and retaining the temperature within a range of Tₓ° C.±3° C. when Tₓ° C. is set as the predetermined temperature (Tₓ).

The predetermined first temperature is to be maintained for 10 minutes or longer but is maintained preferably for 30 minutes or longer and more preferably for 60 minutes or longer. In terms of reducing the total polymerization time, the upper limit for maintaining the predetermined first temperature is preferably for 300 minutes or shorter and more preferably for 240 minutes or shorter. Maintaining the predetermined first temperature for 10 minutes or longer allows the molecular weight to be increased in a shorter time.

### Third Polymerization

In the third polymerization, a predetermined second temperature (T₂) of 235° C. to 245° C. is maintained for shorter than 2 hours after the second polymerization to continue the polymerization reaction. Maintaining the high temperature continuously from the second polymerization allows the polymerization reaction to continue in a state where the phase-separated state is maintained. In addition, the PAS is turned into particles in the third polymerization. Turning the PAS into particulate form in the middle of the polymerization allows a PAS with a small particle size to be formed.

The predetermined second temperature (T₂), which is the polymerization temperature of the third polymerization, is 235° C. or higher. From the perspective of obtaining a PAS in particulate form, the predetermined second temperature is preferably 237° C. or higher. In addition, the upper limit of the second predetermined temperature is 245° C. or lower but is preferably 243° C. or lower from the perspective of preventing particle size enlargement.

The relationship between the polymerization temperature (T₁) of the second polymerization and the polymerization temperature (T₂) of the third polymerization is T₁-T₂>5° C. From the perspective of reducing the polymerization time, T₁-T₂ is preferably higher than 15° C. and more preferably higher than 20° C. In addition, T₁-T₂<55° C., and from the perspective of preventing degradation, T₁-T₂ is preferably lower than 40° C. and more preferably lower than 30° C.

The predetermined second temperature is maintained for shorter than 2 hours but preferably for 1 hour or shorter and preferably for 0.5 hours or shorter from the perspective of reducing the polymerization time. In addition, the lower limit is preferably 0.1 hours or longer to form the particles.

### Fourth Polymerization

In the fourth polymerization, the polymerization reaction is continued at a predetermined third temperature (T₃) of 240° C. or higher and lower than 250° C. after the third polymerization. Maintaining the high temperature continuously from the third polymerization allows the polymerization reaction to continue in a state where the phase-separated state is maintained. The polymerization reaction proceeds also at the temperature of the second polymerization, but the polymerization temperature is increased to reduce the polymerization time.

The predetermined third temperature (T₃), which is the polymerization temperature of the fourth polymerization, is 240° C. or higher, but from the perspective of reducing the polymerization time, increasing the polymerization temperature as much as possible reduces the polymerization time. The predetermined third temperature is preferably higher than 242° C. and more preferably 244° C. or higher. In addition, the upper limit is 250° C. or lower, but the particles formed at T₂ may be remelted and enlarge at higher polymerization temperatures. Thus, from the perspective of preventing the enlargement of the particle size of the PAS, the upper limit is preferably 248° C. or lower and more preferably 246° C. or lower.

The relationship between the polymerization temperature (T₁) of the second polymerization and the polymerization temperature (T₃) of the fourth polymerization is T₁>T₃. This can prevent melting of the particles and maintain the particle shape. Here, T₁-T₃>5° C., and from the perspective of reducing the polymerization time, T₁-T₃ is preferably higher than 10° C. and more preferably higher than 15° C. In addition, T₁-T₃<50° C., and from the perspective of preventing degradation of the PAS, T₁-T₃ is preferably lower than 25° C. and more preferably lower than 20° C.

In addition, the relationship between the polymerization temperature (T₂) of the third polymerization and the polymerization temperature (T₃) of the fourth polymerization is T₃>T₂.

Furthermore, in the method for producing a polyarylene sulfide according to the present invention, the relationship among the above T₁, T₂, and T₃ is T₁>T₃>T₂. With the relationship of T₁>T₃>T₂, a high molecular weight PAS with a small particle size can be obtained in a shorter time. The relationship of T₁>T₂ allows the formation of a PAS with a small particle size. In addition, the relationship of T₁>T₃>T₂ allows acceleration of the polymerization reaction while maintaining the particle size, thus reducing the polymerization time.

The predetermined third temperature is maintained for shorter than 20 hours but preferably for 15 hours or shorter and preferably for 10 hours or shorter from the perspective of reducing the total polymerization time. In addition, the lower limit is 1 hour or longer, preferably 3 hours or longer, and more preferably 5 hours.

Total polymerization time of second polymerization, third polymerization, and fourth polymerization

The total of the polymerization time of the second polymerization, the polymerization time of the third polymerization, and the polymerization time of the fourth polymerization is preferably 30 hours or shorter, more preferably 25 hours or shorter, and even more preferably 20 hours or shorter from the perspective of reducing the total polymerization time.

### Physical Properties of Polyarylene Sulfide

The average particle size of the PAS obtained by the method for producing a polyarylene sulfide according to the present invention is preferably 200 μm or greater, more preferably from 400 to 1500 μm, and even more preferably from 500 to 1000 μm from the perspective of handling properties. The PAS without particle size enlargement has excellent handling properties. In addition, the PAS without particle size enlargement facilitates washing of an apparatus and can prevent blocking of piping. Furthermore, particle size enlargement of the PAS is prevented, and thus this can provide a PAS with excellent handling properties even using high concentrations of the raw materials, such as the sulfur source and the dihalo aromatic compound.

In the method according to the present invention, the melt viscosity of the granular PAS measured at a temperature of 310° C. and a shear rate of 1216 sec⁻¹ is preferably 50 Pa·s or greater, more preferably from 80 to 500 Pa·s, and even more preferably from 100 to 300 Pa·s. The melt viscosity of the granular PAS can be measured using Capilograph at a predetermined temperature and shear rate condition and using about 20 g of a dry polymer.

### SUMMARY

As described above, an aspect of the method for producing a polyarylene sulfide according to the present invention includes: first polymerization in which a mixture containing a sulfur source and a dihalo aromatic compound in an organic amide solvent is heated to initiate a polymerization reaction and produce a reaction mixture; phase separation agent addition in which a phase separation agent is added to the reaction mixture after the first polymerization step; second polymerization in which a predetermined first temperature (T₁) from 240° C. to 290° C. is maintained for 10 minutes or longer after the phase separation agent addition to continue the polymerization reaction; third polymerization in which a predetermined second temperature (T₂) from 235° C. to 245° C. is maintained for shorter than 2 hours after the second polymerization to continue the polymerization reaction; and fourth polymerization in which the polymerization reaction is continued at a predetermined third temperature (T₃) of 240° C. or higher and lower than 250° C. after the third polymerization, in which a relationship among the T₁, T₂, and T₃ is T₁>T₃>T₂.

In addition, a relationship between the T₁ and T₃ is preferably T₁-T₃>5° C.

Furthermore, in the first polymerization, the polymerization is preferably performed until a conversion rate of the dihalo aromatic compound is from 50 to 98 mol %.

Examples will be shown below to describe embodiments of the present invention in further detail. The present invention is of course not limited to the examples below, and it goes without saying that various aspects are possible for the details. Furthermore, the present invention is not limited to the embodiments described above, and various modifications are possible within the scope indicated in the claims. Embodiments obtained by appropriately combining the technical means disclosed by the embodiments are also included in the technical scope of the present invention. In addition, all documents described in the present specification are incorporated by reference.

### EXAMPLES

### Measurement Methods

### (1) Average Particle Size

The average particle size of a granular PAS was measured by screening using sieves with a sieve opening of 2800 μm (7 meshes (mesh counts/inch)), a sieve opening of 1410 μm (12 meshes (mesh counts/inch)), a sieve opening of 1000 μm (16 meshes (mesh counts/inch)), a sieve opening of 710 μm (24 meshes (mesh counts/inch)), a sieve opening of 500 μm (32 meshes (mesh counts/inch)), a sieve opening of 250 μm (60 meshes (mesh counts/inch)), a sieve opening of 150 μm (100 meshes (mesh counts/inch)), a mesh opening of 105 μm (145 meshes (mesh counts/inch)), a mesh opening of 75 μm (200 meshes (mesh counts/inch)), and a mesh opening of 38 μm (400 meshes (mesh counts/inch)). Specifically, from mass of the oversize fraction on each sieve, the particle size when the cumulative mass was 50 mass % was calculated as the average particle size.

(2) Melt Viscosity

The melt viscosity of a granular PAS was measured by Capirograph 10 (trade name) available from Toyo Seiki Seisaku-sho, Ltd. equipped with a nozzle of 1.0 mm φ and 10.0 mm in length as a capillary. The temperature was set to 310° C. A polymer sample was introduced into the apparatus and held for 5 minutes, and then the melt viscosity was measured at a shear rate of 1200 sec⁻¹.

### Example 1

### Water Removal Step

Into a 20-liter autoclave, 6005 g of NMP, 2006 g of aqueous sodium hydrosulfide solution (NaSH: a purity of 61.55 mass %), and 1005 g of sodium hydroxide (NaOH: a purity of 73.36 mass %) were charged. After purging the autoclave with nitrogen gas, the temperature was gradually increased to 200° C. under stirring with a stirrer at a rotational speed of 250 rpm over about 2 hours, and 970 g of water (H₂O), 780 g of NMP, and 0.5 mol of hydrogen sulfide (H₂S) were distilled off.

### Polymerization

After the above water removal step, the contents in the autoclave were cooled to 150° C., 3183 g of p-dichlorobenzene (hereinafter pDCB), 2846 g of NMP, 4.2 g of sodium hydroxide, and 31 g of water were added, and the temperature was increased under stirring. First polymerization was performed by increasing the temperature from 220° C. to 250° C. over 1.5 hours and reacting the contents. The ratio (g/mol) of NMP/charged sulfur source (hereinafter abbreviated as the “charged S”) in the autoclave was 375. When the temperature reached 250° C., 554.5 g of water and 128.7 g of sodium hydroxide were injected. The rotational speed of the stirring was set at 400 rpm, and the temperature was increased to 265° C.

Second polymerization was performed at 265° C. for 1.5 hours, the contents were cooled from 265° C. to 240° C. over 30 minutes, and the polymerization was continued at 240° C. for 30 minutes (third polymerization). Furthermore, the temperature was increased from 240° C. to 245° C. over 15 minutes, and the polymerization was performed at 245° C. for 3 hours (fourth polymerization). Then, the contents in the autoclave were cooled to room temperature, and a PAS polymer-containing solution was obtained. The contents were screened with a sieve with an opening diameter of 150 μm (100 meshes), washed with acetone and ion-exchanged water, then washed with an aqueous acetic acid solution, dried, and a granular PPS was obtained.

Physical properties of the resulting polymer are shown in Table 1. A PAS with an average particle size of 877 μm was obtained.

### Comparative Example 1

Procedures were performed in the same manner as in Example 1 until the second polymerization, then the contents were cooled from 265° C. to 245° C. over 30 minutes. The polymerization was performed at 245° C. for 3.5 hours (fourth polymerization), and a PAS polymer-containing solution was obtained. In Comparative Example 1, the third polymerization was not performed. The resulting polymer-containing solution was collected in the same manner as in Example 1. Physical properties of the resulting polymer are shown in Table 1. A PAS with an average particle size of 1342 μm was obtained.

### Example 2

### Water Removal Step

Into a 20-liter autoclave, 5998 g of NMP, 1931 g of aqueous sodium hydrosulfide solution (NaSH: a purity of 62.29 mass %), and 1082 g of sodium hydroxide (NaOH: a purity of 73.18 mass %) were charged. After purging the autoclave with nitrogen gas, the temperature was gradually increased to 200° C. under stirring with a stirrer at a rotational speed of 250 rpm over about 2 hours, and 875 g of water (H₂O), 858 g of NMP, and 0.4 mol of hydrogen sulfide (H₂S) were distilled off.

### Polymerization

After the above water removal step, the contents in the autoclave were cooled to 150° C., 3145 g of pDCB, 2818 g of NMP, 8.2 g of sodium hydroxide, and 76 g of water were added, and temperature was increased under stirring. First polymerization was performed by reacting the contents at 220° C. for 1 hour, increasing the temperature to 230° C. over 30 minutes, and reacting the contents for 90 minutes.

The ratio (g/mol) of NMP/charged sulfur source (hereinafter abbreviated as the “charged S”) in the autoclave was 382. Then, 375 g of NMP, 555 g of water, and 129 g of sodium hydroxide were injected to make the NMP content be 400 g/mol, the rotational speed of the stirring was set at 400 rpm, and the temperature was increased to 260° C.

Then, the second polymerization was performed at 260° C. for 3 hours, then the contents were cooled to 240° C. over 30 minutes, and the polymerization was continued at 240° C. for 60 minutes (third polymerization). Furthermore, the temperature was increased from 240° C. to 245° C. over 15 minutes, the polymerization was performed at 245° C. for 6.5 hours (fourth polymerization), and a polymer-containing solution was obtained. The resulting polymer-containing solution was collected in the same manner as in Example 1. Physical properties of the resulting polymer are shown in Table 2.

### Example 3 30

Into a 1-liter autoclave, 576 g of a slurry of Example 2 before adding a phase separation agent was charged, and 16.2 g of NMP, 23.1 g of H₂O, and 2.1 g of NaOH were further charged. After purging the autoclave with nitrogen gas, the temperature was increased to 260° C. under stirring at a rotational speed of 400 rpm. After the second polymerization was performed at 260° C. for 3 hours, the contents were cooled to 240° C. over 30 minutes, and the polymerization was continued at 240° C. for 60 minutes (third polymerization). Furthermore, the temperature was increased from 240° C. to 245° C. over 15 minutes, and the polymerization was performed at 245° C. for 5 minutes (fourth polymerization). Then, the stirring was stopped, and the contents were cooled. The center of the resulting polymer was in particulate form, and the particles were estimated to be formed in the third polymerization, and the particles were estimated to be maintained also at the temperature of the fourth polymerization.

### Comparative Example 2

Procedures were performed in the same manner as in Example 3 with the exception that the fourth polymerization temperature was set to 255° C. The resulting polymer combined (agglomerated) so as not to be removed from a stirring shaft. Thus, the particles were estimated to be remelted if the fourth polymerization temperature is 255° C.

### Comparative Example 3

### Water Removal Step

Into a 20-liter autoclave, 6001 g of NMP, 1982 g of aqueous sodium hydrosulfide solution (NaSH: a purity of 62.47 mass %), and 1190 g of sodium hydroxide (NaOH: a purity of 74.15 mass %) were charged. After purging the autoclave with nitrogen gas, the temperature was gradually increased to 200° C. under stirring with a stirrer at a rotational speed of 250 rpm over about 2 hours, and 935 g of water (H₂O), 1007.1 g of NMP, and 0.3 mol of hydrogen sulfide (H₂S) were distilled off.

### Polymerization

After the above water removal step, the contents in the autoclave were cooled to 150° C., 3276 g of pDCB, 3160 g of NMP, 9.3 g of sodium hydroxide, and 102 g of water were added, and temperature was increased under stirring. First-stage polymerization was performed by reacting the contents at 220° C. for 4 hours. The ratio (g/mol) of NMP/charged sulfur source (hereinafter abbreviated as the “charged S”) in the autoclave was 375. Then, 588 g of water was injected. The rotational speed was set at 400 rpm, and the temperature was increased. The contents were polymerized at 260° C. for 3 hours then at 255° C. for 3 hours, cooled from 255° C. to 245° C. over 40 minutes, and polymerized at 245° C. for 7.5 hours. The resulting polymer-containing solution was collected in the same manner as in Example 1. Physical properties of the resulting polymer are shown in Table 2.

### Comparative Example 4

### Water Removal Step

Into a 20-liter autoclave, 6499 g of NMP, 1803 g of aqueous sodium hydrosulfide solution (NaSH: a purity of 62.47 mass %), and 1071 g of sodium hydroxide (NaOH: a purity of 74.15 mass %) were charged. After purging the autoclave with nitrogen gas, the temperature was gradually increased to 200° C. under stirring with a stirrer at a rotational speed of 250 rpm over about 2 hours, and 851 g of water (H₂O), 807 g of NMP, and 0.4 mol of hydrogen sulfide (H₂S) were distilled off.

### Polymerization

After the above water removal step, the contents in the autoclave were cooled to 150° C., 2977 g of pDCB, 3161 g of NMP, 7.9 g of sodium hydroxide, and 160 g of water were added, and temperature was increased under stirring. First-stage polymerization was performed by reacting the contents at 220° C. for 4 hours. The ratio (g/mol) of NMP/charged sulfur source (hereinafter abbreviated as the “charged S”) in the vessel was 450. Then, 610 g of water was injected. The rotational speed of the stirring was set at 400 rpm, and the temperature was increased to 260° C.

The contents were polymerized at 260° C. for 3 hours then at 255° C. for 3 hours, cooled from 255° C. to 245° C. over 40 minutes, and polymerized at 245° C. for 7.5 hours. The resulting polymer-containing solution was collected in the same manner as in Example 1. Physical properties of the resulting polymer are shown in Table 2.

TABLE 1

| | | | Comparative | |
|---|---|---|---|---|
| | Example 1 | | Example 1 | |
| Polymerization conditions | Temperature | Time | Temperature | Time |
| Second polymerization | 265 | 1.5 | 265 | 1.5 |
| Third polymerization | 240 | 0.5 | — | — |
| Fourth polymerization | 245 | 3 | 245 | 3.5 |

| | | |
|---|---|---|
| Melt viscosity (Pa · s) | 103 | 97 |
| Average particle size | 877 | 1342 |
| (μm) | | |

TABLE 2

| | | | Comparative | | Comparative | |
|---|---|---|---|---|---|---|
| | Example 2 | | Example 3 | | Example 4 | |
| Polymerization conditions | Temperature | Time | Temperature | Time | Temperature | Time |
| Second polymerization | 260 | 3 | 255 | 3 | 255 | 3 |
| Third polymerization | 240 | 1 | — | — | | |
| Fourth polymerization | 245 | 6.5 | 245 | 7.5 | 245 | 7.5 |

| | | | |
|---|---|---|---|
| Amount of NMP added | 400 | 375 | 450 |
| afterwards | | | |
| Melt viscosity (Pa · s) | 236 | 250 | 235 |
| Average particle size | 1466 | 3237 | 2061 |
| (μm) | | | |

### Results

In Example 1, in which the relationship among the polymerization temperatures T₁ in the second polymerization, T₂ in the third polymerization, and T₃ in the fourth polymerization was T₁>T₃>T₂, a PAS with a small average particle size and excellent handling properties was obtained.

In Comparative Example 1, in which the third polymerization was not performed, particles were formed when the melt viscosity was high, thus resulting in a larger average particle size and poor handling properties.

In addition, among examples in which NMP was added afterwards, in Example 3, in which the relationship among the polymerization temperatures T₁ in the second polymerization, T₂ in the third polymerization, and T₃ in the fourth polymerization was T₁>T₃>T₂, a PAS with a small average particle size and excellent handling properties was obtained.

1. A method for producing a polyarylene sulfide, the method comprising:
first polymerization in which a mixture containing a sulfur source and a dihalo aromatic compound in an organic amide solvent is heated to initiate a polymerization reaction and produce a reaction mixture;
phase separation agent addition in which a phase separation agent is added to the reaction mixture after the first polymerization;
second polymerization in which a predetermined first temperature (T1) from 240° C. to 290° C. is maintained for 10 minutes or longer after the phase separation agent addition to continue the polymerization reaction;
third polymerization in which a predetermined second temperature (T2) from 235° C. to 245° C. is maintained for 0.1 hours or longer and shorter than 2 hours after the second polymerization to continue the polymerization reaction; and
fourth polymerization in which the polymerization reaction is continued at a predetermined third temperature (T3) of 240° C. or higher and lower than 250° C. after the third polymerization,
wherein a relationship among T1, T2, and T3 is T1>T3>T2.

2. The method for producing a polyarylene sulfide according to claim 1, wherein a relationship between T1 and T3 is T1-T3>5° C.

3. The method for producing a polyarylene sulfide according to claim 1, wherein, in the first polymerization, the polymerization is performed until a conversion rate of the dihalo aromatic compound is from 50 to 98 mol %.
